(19) United States
(12) Patent Application Publication
(10) Pub. No.: US 2006/0022945 A1
(43) Pub. Date: Feb. 2, 2006

(54) Reducing dust contamination in optical mice

(76) Inventors: Dietrich W. Vook, Los Altos, CA (US); Daniel B. Roitman, Menlo Park, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/903,519

(22) Filed: Jul. 30, 2004

(51) Int. Cl. G09G 5/08

(52) U.S. Cl. 345/166

(57) ABSTRACT

Reduction of dust contamination in optical mice. Optical elements are made electrically conductive, reducing static charges which attract dust particles. Plastic optical elements may be made conductive through the use of conductive polymers. Optical elements in plastic or glass may be made conductive by coating them with materials which are conductive but pass wavelengths of interest. Multi-layer coatings may be used. Indium tin oxide is a coating of interest, and coatings of metals such as gold, silver, tin, or zinc, and their compounds, may be used.

### TECHNICAL FIELD

Embodiments in accordance with the invention are related to optical mice, and methods of reducing dust contamination in optical mice.

### BACKGROUND

The computer mouse used for navigation on personal computers has evolved significantly since its invention by Douglas Engelbart, as shown in his U.S. Pat. No. 3,541,541.

The modern computer mouse is not mechanical, but optical. An optical mouse is described in U.S. Pat. No. 6,433,780 by Gordon et al, incorporated herein by reference. An optical mouse has a motion sensor with a light source which illuminates the surface the mouse rests upon. Optical elements focus an image of this surface on an image sensor. Processing electronics connected to the image sensor sense motion by correlating successive images from the image sensor, performing a correlation of successive images with different offsets in X and Y directions, and finding the maximum of the correlation surface.

Dust contamination of the optical elements reduces the effectiveness of the optical mouse by creating a fixed pattern in sensed images. While this is less of a problem with mice which use conventional imaging, since such dust is out of the focal plane, it is of particular concern in optical mice using interference imaging. The fixed pattern created by dust leaves a peak in the correlation function at zero displacement. For small motions, this central peak at zero motion in the correlation function distorts the algorithms which find the sub-pixel resolution peak.

### SUMMARY OF THE INVENTION

Dust contamination on the optical surfaces of optical mice is reduced by using conductive plastics for the optical surfaces. Conductive polymers may be mixed in with the plastic forming the optical element, or conductive materials may be applied to the surface. Transparent conducting polymers may be used, as well as known materials such as metal films including indium tin oxide. Such films may be applied to either plastic or glass optical elements.

### BRIEF DESCRIPTION OF THE DRAWING

FIG. 1 shows a view of an optical mouse, and

FIG. 2 shows conductive optical parts.

### DETAILED DESCRIPTION OF THE EMBODIMENTS

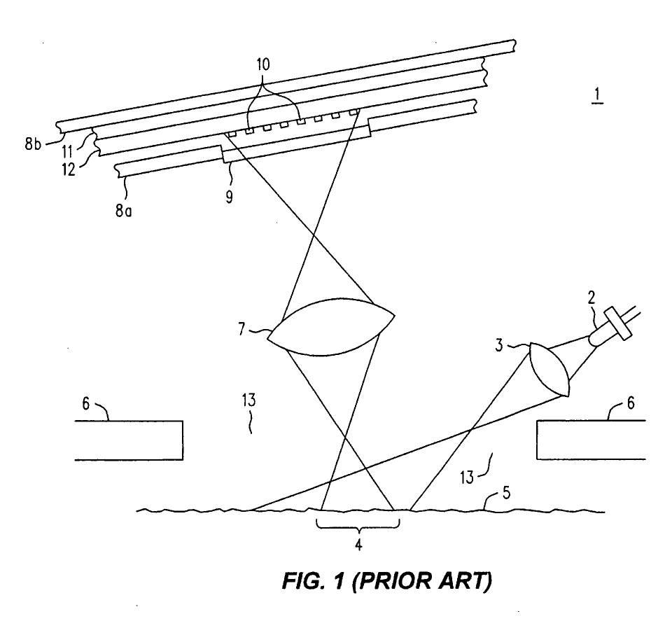

FIG. 1 shows a cut-away side-view of an optical mouse 1 known to the art. Light source 2 emits light which is projected by lens 3 (which may be separate as shown, or may be integrated into the package of source 2), through orifice 13 in bottom surface 6 and onto a region 4 that is part of a work surface 5. Although omitted for clarity, orifice 13 might include a window transparent to the light from source 2, and which serves to keep dust, dirt, or other contamination out of the innards of mouse 1. Light from the illuminated region 4 illuminated photodetector array 10 through window 9 and lens 7. Integrated circuit package portion 8a may dispense with separate window 9 and lens 7 by combining them into one and the same element. Photodetector array 10 is fabricated onto a portion of an integrated circuit die 12 affixed by adhesive 11 or other means to package portion 8b. Photodetector array 10 sends image data to a processor, not shown for purposes of clarity.

The processor deduces X and Y motion by correlating successive images from image sensor 10. Successive images are correlated with different X and Y offsets, producing a correlation surface. The maximum on this correlation surface gives the X and Y offset between images, and therefore the X and Y motion.

Dust contamination on optical surfaces reduces the effectiveness of this process by creating a fixed pattern on these images. This fixed pattern leaves a peak in the correlation function at zero displacement, zero motion. For small motions, this central peak in the correlation function at zero motion distorts the algorithms searching for correlation peaks.

According to the present invention, providing electrically conductive optical elements acts to dissipate static charges on the optical elements. Reduced static charges reduce the attraction of dust particles.

Referring to FIG. 1, candidates for such treatment include optical elements 3, 7, and any covering of orifice 13. A candidate for such treatment will be an optical surface which is exposed to the environment and susceptible to dust contamination.

The resulting optical element, of course, must retain its optical properties. In practice, the optical components are molded from plastic. One method of obtaining the desired conductivity is to use a conductive polymer such as polythiophene in the plastic.

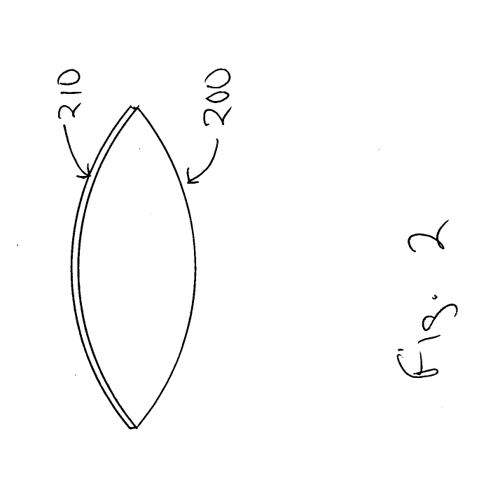

A second method is to coat the optical element with conductive material. Coatings may be applied to plastic or glass optical elements. The entire element may be coated, or only the surface which will be exposed to dust need be coated. As shown in FIG. 2, optical element 200 has coated surface 210. Note that the relative thickness of coated surface 210 as shown is not to scale; in practice, the coating may only be microns thick. Many methods may be used, including but not limited to dipping, spraying, sputtering, vacuum deposition, evaporation, ion-plating, and die sublimation.

Metal films known to the art may be used. Thin layers of metals such as gold, silver, tin, zinc, and indium are optically transparent yet provide the required electrical conductivity. Transparent and conductive oxides (TCOs) based on oxidic semiconductors with large bandgaps such as ZnO, SnO₂ and In₂O₃ may be used. One popular material known to the art is indium tin oxide (ITO, In₂O₃:Sn), widely used in touch-screens and digitizing overlays on displays.

It is well known in the optical arts to provide multiple-layer coatings on optical elements to improve optical transmission and reduce reflection. According to the present invention, such multi-layer coatings may be used, provided that the outer layer is an electrically conductive layer. An example of such a multi-layer process starts with an optical component base, a TiO₂ film, SiO₂ film, and then an ITO film.

Low resistances are not required to dissipate static charges on the optical element. This allows very thin conductive layers to be used.

While the embodiments of the present invention have been illustrated in detail, it should be apparent that modifications and adaptations to these embodiments may occur to one skilled in the art without departing from the scope of the present invention as set forth in the following claims.

1. An improved motion sensor in an optical mouse, the motion sensor having an optical element, the optical element having at least one surface which is electrically conductive.

2. The improved motion sensor of claim 1 where the electrically conductive optical element is a plastic containing a conductive polymer.

3. The improved motion sensor of claim 2 where the conductive polymer is polythiophene.

4. The improved motion sensor of claim 1 where the electrically conductive surface is a coated surface.

5. The improved motion sensor of claim 4 where the coated surface contains a layer of indium tin oxide.

6. The improved motion sensor of claim 4 where the coated surface contains a layer selected from one of: gold, silver, tin, zinc, indium.
